(19) United States
(12) Patent Application Publication
(10) Pub. No.: US 2026/0048852 A1
(43) Pub. Date: Feb. 19, 2026

(54) CONTACTOR CONTROL UNITS

(71) Applicant: Hamilton Sundstrand Corporation, Charlotte, NC (US)

(72) Inventors: Robert L. Seagren, Rockford, IL (US); Jef William Good, German Valley, IL (US); Joshua D. Berg, Roscoe, IL (US)

(21) Appl. No.: 18/806,373

(22) Filed: Aug. 15, 2024

(51) Int. Cl. B64D 41/00; H02J 1/00

(52) U.S. Cl. CPC B64D 41/00; H02J 1/00; B64D 2221/00

(57) ABSTRACT

A contactor control unit (CCU) includes a communication interface configured to be coupled to a power controller. The CCU also includes one or more switches, each associated with a contactor in a power distribution system that includes one or more contactors and configured to control a driving current for switching the associated contactor between its “on” and “off” power states. The CCU further includes a controller configured to receive, from the power controller, a first signal to switch a power state of a first contactor of the one or more contactors. The controller is also configured to convert the first signal to a control signal applied to the switch associated with the first contactor, receive a second signal indicating a power state of an element controlled by the first contactor, and send the second signal to the power controller.

### TECHNICAL FIELD

This disclosure relates generally to power distribution and power management systems. More specifically, this disclosure relates to contactor control units.

### BACKGROUND

Many aerospace applications have power networks whose architectures employ multiple contactors (such as electrically-actuated switches in which a driving current is applied to actuate a contactor motor to open or close the contactor main contacts) to perform switching operations associated with distributing electric power throughout an aircraft. Historically, each contactor is driven by its own driver, where the drivers and their associated sensing circuitries (such as DC Hall effect sensors, AC current sensors, or voltage sensors) are all connected to a single power controller, such as bus power control unit (“BPCU”) or equivalent controller, in a hub-and-spoke architecture with the BPCU as the hub.

### SUMMARY

This disclosure relates to contactor control units.

In some examples, a contactor control unit (CCU) may include a communication interface configured to be coupled, via a communication bus, to a power controller, such as a bus power control unit (BPCU). The CCU may also include one or more output switches, where each switch may be associated with a contactor in a power distribution system that includes one or more contactors. Each switch may be configured to control a driving current for switching the associated contactor between its “on” and “off” power states. The CCU may further include a controller that may be configured to receive, via the communication interface from the controller, a first signal to switch a power state of a first contactor of the one or more contactors. The controller may also be configured to convert the first signal to a control signal applied to the switch associated with the first contactor. The controller may further be configured to receive, from one or more sensors, a second signal indicating a power state of an element controlled by the first contactor. In addition, the controller may be configured to send the second signal, via the communication interface, to the BPCU.

In other examples, a power distribution system may include a power controller (for example, a BPCU) and one or more contactors, where each contactor is configured to open or close an electrical connection. The power distribution system may also include a bus communicatively coupled to the power controller. The power distribution system may further include a first CCU communicatively coupled to the power controller via the bus. The first CCU may include a communication interface coupled, via the bus, to the power controller. The first CCU may also include one or more switches, where each switch may be associated with one of the one or more contactors. Each switch may be configured to control a driving current for switching the associated contactor between its “on” and “off” power states. The first CCU may further include a controller that may be configured to receive, via the communication interface from the power controller, a first signal to switch a power state of a first contactor of the one or more contactors. The controller may also be configured to convert the first signal to a control signal applied to the switch associated with the first contactor. The controller may further be configured to receive, from one or more sensors, a second signal indicating a power state of an element controlled by the first contactor. In addition, the controller may be configured to send the second signal, via the communication interface, to the power controller.

In still other examples, a non-transitory machine readable medium may contain instructions that, when executed by at least one processor of a CCU, cause the CCU to receive, via a communication interface coupled via a bus to a power controller (for example, a BPCU), a first signal to switch a power state of a first contactor of one or more contactors in a power distribution system. The non-transitory machine readable medium may also contain instructions that, when executed by the at least one processor, cause the CCU to convert the first signal to a control signal applied to a switch associated with the first contactor among one or more switches. Each switch may be configured to control a driving current for switching the associated contactor between its “on” and “off” power states. The non-transitory machine readable medium may further contain instructions that, when executed by the at least one processor, cause the CCU to receive, from one or more sensors, a second signal indicating a power state of an element controlled by the first contactor. In addition, the non-transitory machine readable medium may contain instructions that, when executed by the at least one processor, cause the CCU to send the second signal, via the communication interface, to the BPCU.

Any single one or any combination of the following features may be used with the examples above. Communications with the power controller, via the communication bus, may occur according to an aircraft compatible communication protocol. An external input/output (I/O) interface may be coupled to the controller and the one or more sensors. For each contactor of the one or more contactors, the external I/O interface may be coupled to at least one of: a current transformer sensor associated with the contactor, a voltage sensor associated with the contactor, a Hall effect sensor associated with the contactor, and an auxiliary sensor indicating a power state of the contactor. The CCU may include an onboard power supply configured to be coupled to a DC bus of an aircraft. The onboard power supply may be configured to provide a stable power supply for the controller and to provide a driving current for the one or more contactors through the one or more switches. The CCU may include an identifier package configured to provide a unique identifier of the contactor control unit among a plurality of contactor control units connected to the power controller. The CCU may include receive feedback from each switch regarding a power state of the switch. The CCU may replace at least one of: a direct connection between the power controller and a contactor and a direct connection between the power controller and the one or more sensors. The communication interface of the CCU may be configured to communicate with the power controller, via the bus, according to one or more of: a control area network bus (CANBUS) protocol, a FlexRay protocol, an ARINC 429 protocol, a local interconnect network (LIN) protocol, and a single-pair Ethernet (SPE) protocol. The power controller may be a bus power control unit (BPCU). The CCU may include a power storage device. The power distribution system may include a second CCU communicatively coupled to the power controller via a second bus, wherein the power controller distinguishes between the first CCU and the second CCU based on an identifier package of the first CCU. The first CCU may be provided as a removable card disposed in a distribution panel of an aircraft.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates example technical problems addressed by embodiments according to this disclosure;

FIG. 2 illustrates an example architecture of a power distribution network according to this disclosure; and

FIG. 3 illustrates an example contactor control unit (CCU) according to this disclosure.

### DETAILED DESCRIPTION

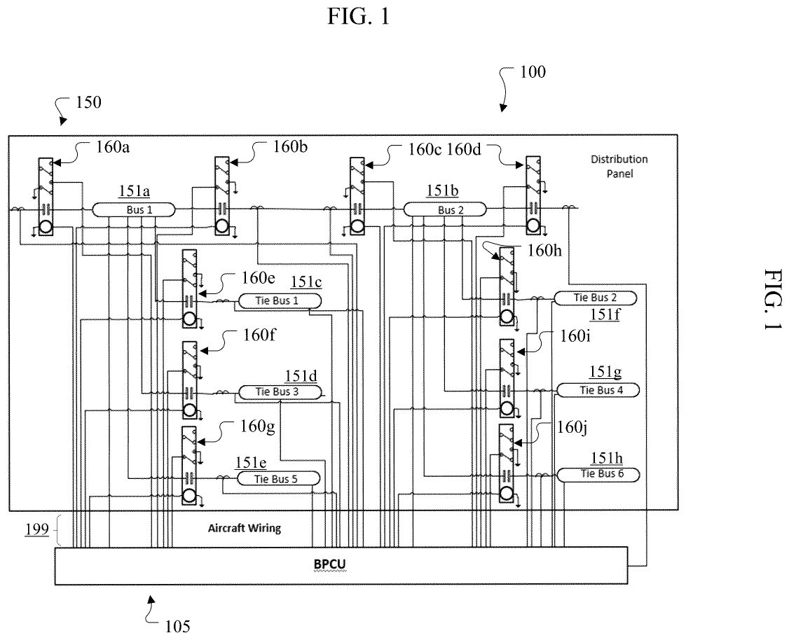

FIGS. 1 through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, many aerospace applications have power networks whose architectures employ multiple contactors (such as electrically-actuated switches in which a driving current is applied to actuate a contactor motor to open or close the contactor) to perform switching operations associated with distributing electric power throughout an aircraft. Historically, each contactor is driven by its own driver, where the drivers and their associated sensing circuitries (such as DC Hall effect sensors, sensors on transformers, or sensors on AC burden resistors) are all connected to a single power controller, such as a bus power control unit (“BPCU”) in a hub-and-spoke architecture with the BPCU as the hub.

For smaller applications, this hub-and-spoke architecture with a single power controller, such as a BPCU as the central node proves workable. However, as the number of contactors and components increases to meet the needs of larger and more complex applications, drawbacks such as size, weight, and power (“SWAP”) penalties of centralized systems become exponentially more apparent. For example, more contactors in a larger airframe often translates to longer cable runs and increased complexity at the BPCU. As a particular example, in a hub-and-spoke architecture in which a BPCU controls contactors and performs current sensing and monitoring, a shift from a four-contactor system to a 25-contactor system may increase the size and complexity of the BPCU by a factor of six. Additionally, centralizing control at a single hardwired BPCU can impede upgrades and reconfigurations of the system over the course of an airframe's life. This disclosure provides various contactor control units that can overcome these or other types of issues.

FIG. 1 illustrates example technical problems addressed by embodiments according to this disclosure. More specifically, FIG. 1 illustrates an example aircraft wiring architecture 100 of a power distribution system for controlling a power network. As used in this disclosure, the phrase “power network” encompasses power busses, distribution lines, or other components that provide working power for components of an aircraft or other system.

As shown in FIG. 1, architecture 100 includes two principal components, namely, a power controller, (in this example, BPCU 105) and distribution panel 150. A power network may be controlled by the components of a power distribution system, which can include switches, sensors, or other components used for distributing power across a power network. In some embodiments, BPCU 105 includes logic for controlling a power distribution system. For example, in various embodiments, BPCU 105 includes one or more processing devices. The one or more processing devices may include any suitable number(s) and type(s) of processors or other processing devices in any suitable arrangement. Example types of processing devices include one or more microprocessors, microcontrollers, digital signal processors (DSPs), application specific integrated circuits (ASICs), field programmable gate arrays (FPGAs), or discrete circuitry. The BPCU 105 here can receive, as input, data from one or more sensors, such as one or more voltage sensors dispersed along busses of the power network, one or more contactor auxiliary sensors, or one or more current transformer sensors. Outputs of BPCU 105 may include a coil driving current or other control signal for each contactor of distribution panel 150. In particular embodiments, BPCU 105 can be part of an integrated modular avionics (“IMA”) system.

Distribution panel 150 can include a switching hub for first bus 151a and second bus 151b, as well as tie busses 151c-151h. Connections between these busses can be managed by providing driving signals from BPCU 105 to contactors 160a-160j. In this example, wiring 199 that connects BPCU 105 to distribution panel 150 includes at least seventy separate individual wires to connect all of the inputs and outputs. In many applications, BPCU 105 is located in the electronics bay, which can be provided at a centralized location on the aircraft. However, distribution panel 150 may be located away from BPCU 105 at points aft of the cockpit, such as near an onboard electrical generator. As such, wiring 199 can include hundreds of feet of wires and cabling, adding significant weight to an aircraft and presenting a multitude of potential points of failure within a system with architecture 100.

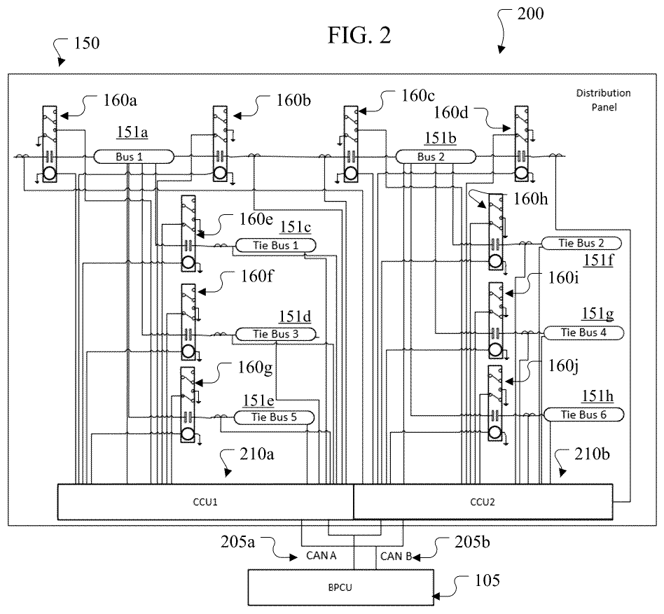

FIG. 2 illustrates an example of an architecture 200 of a power distribution system according to this disclosure. For consistency and convenience of cross-reference, elements of FIG. 2 common to FIG. 1 are numbered similarly. As shown in FIG. 2, architecture 200 includes a power controller (in this case, BPCU 105) and distribution panel 150 but eliminates wires of wiring 199 that directly connect BPCU 105 to distribution panel 150. In this example, wiring 199 is replaced with first bus 205a and second bus 205b. First bus 205a and second bus 205b can be busses implementing any aircraft compatible communication protocol. Examples of busses using aircraft compatible communication protocols include, without limitation: a control area network bus (CANBUS), a FlexRay bus, an ARINC 429 data bus, a local interconnect network (LIN) bus, and a single-pair Ethernet (SPE) protocol. First and second busses 205a-b connect BPCU 105 to first contactor control unit (CCU) 210a and second CCU 210b.

Each CCU 210a and 210b includes one or more modular devices to support switching of one or more power sources for providing driving currents for actuating contactors 160a-160i and for providing sensor data from sensors in the power network to BPCU 105. CCUs 210a and 210b may also be configured to convert digital signals received via first and second busses 205a and 205b into analog control signals for switching controlling the driving currents. Further, CCUs 201a and 210b may be configured to convert analog signals obtained from sensors within the architecture 200 into digital signals for transmission across first and second busses 205a and 205b. In addition, each CCU 210a and 201b may include a communication interface configured to communicate with BPCU 105 according to one or more communication protocols.

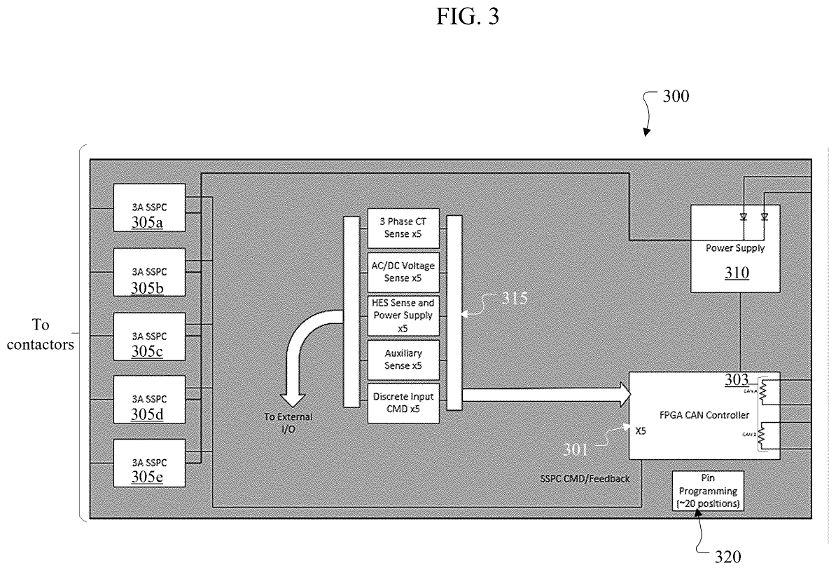

FIG. 3 illustrates an example CCU 300 according to this disclosure. The CCU 300 may, for example, represent each of the CCUs 210a and 210b shown in FIG. 2 and described above. For consistency and convenience of cross-reference, elements of FIG. 3 already described with reference FIG. 2 are numbered similarly. CCU 300 can be realized in a variety of form factors, such as by using a circuit board or a removable card that can be incorporated in a distribution panel or as a standalone unit. Multiple form factors are possible, and the present disclosure is not limited to any one form factor.

A shown in FIG. 3, CCU 300 includes a controller 301, a communication interface 303, one or more switches 305a-305e, a power supply 310, an external input/output (I/O) interface 315, and an identifier package 320. Controller 301 can be implemented according to a variety of hardware options, such as by using one or more processing devices like one or more microprocessors, microcontrollers, DSPs, ASICs, FPGAs, or discrete circuitry. In some cases, controller 301 may include at least one memory (such as a non-transitory memory) containing instructions to be executed by controller 301. Controller 301 can include or be communicatively coupled to communication interface 303, which can be connected to the one or more busses 210a-210b connecting CCU 300 and BPCU 105. Communication interface 303 can be configured to communicate with BPCU 105 over the one or more busses 210a-210b using an aircraft compatible communication protocol, such as a CANBUS, FlexRay, ARINC 429, LIN bus, or SPE protocol. Inputs from one or more sensors connected to controller 301, as well as feedback from switches 305a-305e, can be transmitted to BPCU 105 via communication interface 303. Also, control inputs from BPCU 105 can be provided over busses 205a and 205b and received by controller 301 via communication interface 303.

CCU 300 can also include an onboard power supply 310, which can be connected to and supplied by one or more DC busses of a power network of an aircraft or other system. Power supply 310 can include one or more transformers, filter networks, or other components to step down, smooth, and filter electrical power from an aircraft bus or other bus to at least one voltage and noise level used for actuation of the contactors 160a-160j (such as 28V DC) and powering controller 301 (such as 3.3V or 5.0V DC). Additionally, power supply 310 can include power storage device (for example, a rechargeable battery) to ensure stable and continued operation of CCU 300 in the event of outages in DC power supplied from the aircraft bus or other bus. Power supply 310 can be connected to and can feed a supply current to the contactors 160a-160j of a distribution panel through switches 305a-305c. While CCU 300 in this example has five switches 305a-305e for feeding driving current to contactors, other embodiments with more or fewer switches are possible and within the contemplated scope of this disclosure. Each switch 305a-305e may be associated with and may provide a driving current to one contactor. In some embodiments, each of the switches 305a-305e can be a solid-state power controller (SSPC) switch configured to provide feedback (such as through a trip indicator) if the switch has been rendered inoperative or taken out of a normal operating condition due to an excessive load or other fault condition. In other embodiments, switches 305a-305e can be electromechanical switches, such as relays.

As the example of FIG. 2 illustrates, a distribution panel can include multiple CCUs, and a larger power distribution system can include multiple distribution panels. Thus, BPCU 105 may be connected to a plurality of CCUs, with local control of the contactors of the power distribution system being federated across the multiple CCUs. To correctly route signals between the BPCU 105 and the plurality of CCUs, CCU 300 can include an identifier package 320, which assigns a unique identifier to that CCU within a system potentially including a plurality of CCUs. As CCU 300 can be a modular, swappable component, identifier package 320 in some embodiments can be provided as a dual in-line package (DIP) including a number of switches (such as ten) whose positions define a user-configurable binary number for identifying CCU 300. In other embodiments, identifier package 320 can be provided in a memory of controller 301.

To facilitate replacing many cable runs between a distribution panel and a BPCU 105 (such as using wiring 199 in FIG. 1), CCU 300 can include one or more input/output (I/O) interfaces 315. Recalling example architecture 100 in FIG. 1, wiring 199 includes the wiring between a multitude of sensors within the power network controlled through the contactors in the distribution panel. To reduce or eliminate the cable runs between these sensors and a single BPCU, the sensors of the power network connect to the BPCU 105 through I/O interface 315. As shown in FIG. 3, I/O interface 315 can connect to a variety of sensors found in a power network operating under the control of contactors in a distribution panel (such as distribution panel 150). Examples of sensors that interface with controller 301 through I/O interface 315 can include, for each contactor controlled by controller 301, a current transformer sensor associated with the contactor, a voltage sensor associated with the contactor, a Hall effect sensor associated with the contactor, or an auxiliary sensor indicating a power state of the contactor. I/O interface 315 may optionally include one or more command channels (shown as “discrete input CMD” in FIG. 3) through which control inputs can be provided to sensors or other components of the power network.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A contactor control unit comprising:
a communication interface configured to be coupled, via a bus, to a power controller;
one or more switches, each switch associated with a contactor in a power distribution system that comprises one or more contactors, each switch configured to control a driving current for switching the associated contactor between its “on” and “off” power states; and
a controller configured to:
receive, via the communication interface from the power controller, a first signal to switch a power state of a first contactor of the one or more contactors;
convert the first signal to a control signal applied to the switch associated with the first contactor;
receive, from one or more sensors, a second signal indicating a power state of an element controlled by the first contactor; and
send the second signal, via the communication interface, to the power controller.

2. The contactor control unit of claim 1, wherein the communication interface is configured to communicate with the power controller, via the bus, according to an aircraft compatible communication protocol.

3. The contactor control unit of claim 1, further comprising:
an external input/output (I/O) interface configured to be coupled to the controller and the one or more sensors.

4. The contactor control unit of claim 3, wherein, for each contactor of the one or more contactors, the external I/O interface is coupled to at least one of: a current transformer sensor associated with the contactor, a voltage sensor associated with the contactor, a Hall effect sensor associated with the contactor, or an auxiliary sensor indicating a power state of the contactor.

5. The contactor control unit of claim 1, further comprising:
an onboard power supply configured to be coupled to a DC bus of an aircraft, the onboard power supply configured to provide a stable power supply for the controller and to provide a driving current for the one or more contactors through the one or more switches.

6. The contactor control unit of claim 1, further comprising:
an identifier package configured to provide a unique identifier of the contactor control unit among a plurality of contactor control units connected to the power controller.

7. The contactor control unit of claim 1, wherein the controller is configured to receive feedback from each switch regarding a power state of the switch.

8. A power distribution system comprising:
a power controller;
one or more contactors, each contactor configured to open or close an electrical connection;
a bus communicatively coupled to the power controller; and
a first contactor control unit (CCU) communicatively coupled to the power controller via the bus, the first CCU comprising:
a communication interface coupled, via the bus, to the power controller;
one or more switches, each switch associated with one of the one or more contactors, each switch configured to control a driving current for switching the associated contactor between its “on” and “off” power states; and
a controller configured to:
receive, via the communication interface from the power controller, a first signal to switch a power state of a first contactor of the one or more contactors;
convert the first signal to a control signal applied to the switch associated with the first contactor;
receive, from one or more sensors, a second signal indicating a power state of an element controlled by the first contactor; and
send the second signal, via the communication interface, to the power controller.

9. The power distribution system of claim 8, wherein the communication interface is configured to communicate with the power controller, via the bus, according to one or more of: a control area network bus (CANBUS) protocol, a FlexRay protocol, an ARINC 429 protocol, a local interconnect network (LIN) protocol, and a single-pair Ethernet (SPE) protocol.

10. The power distribution system of claim 8, wherein the first CCU replaces at least one of: a direct connection between the power controller and a contactor or a direct connection between the power controller and the one or more sensors.

11. The power distribution system of claim 8, wherein the power controller is a bus power control unit (BPCU).

12. The power distribution system of claim 8, wherein the first CCU further comprises a power storage device.

13. The power distribution system of claim 8, further comprising a second contactor control unit (CCU) communicatively coupled to the power controller via a second bus;
wherein the power controller distinguishes between the first CCU and the second CCU based on an identifier package of the first CCU.

14. The power distribution system of claim 8, wherein the first CCU is provided as a removable card disposed in a distribution panel of an aircraft.

15. A non-transitory machine readable medium containing instructions that, when executed by at least one processor of a contactor control unit (CCU), cause the CCU to:
receive, via a communication interface coupled via a bus to a power controller, a first signal to switch a power state of a first contactor of one or more contactors in a power distribution system;
convert the first signal to a control signal applied to a switch associated with the first contactor among one or more switches, each switch configured to control a driving current for switching the associated contactor between its “on” and “off” power states;
receive, from one or more sensors, a second signal indicating a power state of an element controlled by the first contactor; and
send the second signal, via the communication interface, to the power controller.

16. The non-transitory machine readable medium of claim 15, wherein the instructions when executed cause the CCU to communicate with the power controller, via the bus, according to an aircraft compatible communication protocol.

17. The non-transitory machine readable medium of claim 15, further containing instructions that, when executed by the at least one processor, cause the CCU to receive, for each contactor of the one or more contactors, information from at least one of: a current transformer sensor associated with the contactor, a voltage sensor associated with the contactor, a Hall effect sensor associated with the contactor, or an auxiliary sensor indicating a power state of the contactor.

18. The non-transitory machine readable medium of claim 15, further containing instructions that, when executed by the at least one processor, cause the CCU to change a power state of a driving current from an onboard power supply for the one or more contactors provided through the one or more switches.

19. The non-transitory machine readable medium of claim 15, further containing instructions that, when executed by the at least one processor, cause the CCU to report a unique identifier of the contactor control unit among a plurality of contactor control units from to the power controller.

20. The non-transitory machine readable medium of claim 15, further containing instructions that, when executed by the at least one processor, cause the CCU to receive feedback from each switch regarding a power state of the switch.
